(19) United States
(12) Patent Application Publication
(10) Pub. No.: US 2022/0042243 A1
(43) Pub. Date: Feb. 10, 2022

(54) INK COMPOSITIONS WITH POLYURETHANE BINDER

(71) Applicant: Hewlett-Packard Development Company, L.P., Spring, TX (US)

(72) Inventors: Zhang-Lin ZHOU, San Diego, CA (US); Qianhan YANG, San Diego, CA (US)

(73) Assignee: Hewlett-Packard Development Company, L.P., Spring, TX (US)

(21) Appl. No.: 17/433,101

(22) PCT Filed: Oct. 1, 2019
(86) PCT No.: PCT/US2019/054012

§ 371 Date: Aug. 23, 2021

(51) Int. Cl. D06P 5/30; C09D 11/102; C09D 11/033; C09D 11/30; D06P 5/20; D06P 1/52; B41J 3/407; B41M 5/00

(52) U.S. Cl. CPC D06P 5/30; C09D 11/102; C09D 11/033; C09D 11/30; D06P 3/60; D06P 1/5292; B41J 3/4078; B41M 5/0023; D06P 5/2077

(57) ABSTRACT

The present disclosure describes ink compositions having a polyurethane binder. In one example, an ink composition can include water, an organic co-solvent, a colorant, and a polyurethane binder. The polyurethane binder can include polymerized prepolymer segments including a polymerized diisocyanate and a polymerized polyol, wherein the prepolymer segments terminate in isocyanate groups. The polyurethane binder can also include polymerized chain extenders connecting the polymerized prepolymer segments. The polymerized chain extenders can include a polymerized siloxane-containing diamine and a polymerized acid-containing diamine.

### BACKGROUND

Inkjet printing has become a popular way of recording images on various media. Some of the reasons include low printer noise, variable content recording, capability of high-speed recording, and multi-color recording. These features can be obtained at a relatively low price to consumers. As the popularity of inkjet printing increases, the types of use also increase providing demand for new ink compositions. In one example, textile printing can have various applications including the creation of signs, banners, artwork, apparel, wall coverings, window coverings, upholstery, pillows, blankets, flags, tote bags, clothing, etc. However, the permanence of printed ink on textiles can be an issue.

### BRIEF DESCRIPTION OF DRAWINGS

FIG. 1 schematically depicts an example textile printing system in accordance with the present disclosure;

FIG. 2 schematically depicts another example textile printing system in accordance with the present disclosure; and

FIG. 3 provides a flow diagram for an example method of textile printing in accordance with the present disclosure.

### DETAILED DESCRIPTION

The present disclosure is drawn to ink compositions that include polyurethane binders, textile printing systems that include ink compositions having polyurethane binders, and methods of textile printing with ink compositions that include polyurethane binders. In one example, an ink composition includes water, an organic co-solvent, a colorant, and a polyurethane binder. The polyurethane binder includes polymerized prepolymer segments including a polymerized diisocyanate and a polymerized polyol, wherein the prepolymer segments terminate in isocyanate groups. The polyurethane binder also includes polymerized chain extenders connecting the polymerized prepolymer segments, wherein the polymerized chain extenders include a polymerized siloxane-containing diamine. In certain examples, the diisocyanate can include 2,2,4-trimethylhexane-1,6-diisocyanate (TMDI); 2,4,4-trimethylhexane-1,6-diisocyanate (TMDI); isophorone diisocyanate (IPDI); 1,3-bis(isocyanatamethyl)cyclohexane (H6XDI); hexamethylene diisocyanate (HDI); methylene diphenyl diisocyanate (MDI); 4,4′-methylene dicyclohexyl diisocyanate (H12MDI); or a combination thereof. In further examples, the siloxane-containing diamine can have general structure:

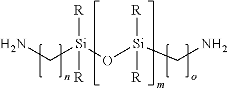

where the R groups are independently methyl, ethyl, or propyl, where n and o are independently integers from 1 to 10, and where m is an integer from 1 to 200. In a specific example, the acid-containing diamine can be 2-((2-aminoethyl)amino)ethanesulphonate. In further examples, the polyurethane binder further includes a polymerized acid-containing diamine chain extender connecting polymerized prepolymer segments, and the polyurethane binder has an acid number less than 50. In some examples, the polyurethane binder can be present in an amount from 0.1 wt % to 30 wt % with respect to the total weight of the ink composition.

The present disclosure also describes textile printing systems. In one example, a textile printing system includes a fabric substrate and an inkjet printhead in fluid communication with a reservoir containing an ink composition to eject the ink composition. The ink composition includes water, an organic co-solvent, a colorant, and a polyurethane binder. The polyurethane binder includes polymerized prepolymer segments including a polymerized diisocyanate and a polymerized polyol, wherein the prepolymer segments terminate in isocyanate groups. The polyurethane binder also includes a polymerized siloxane-containing diamine chain extender connecting polymerized prepolymer segments. In some examples, the fabric substrate can include cotton, polyester, silk, nylon, or a blend thereof. In other examples, the polyurethane binder can also include a polymerized acid-containing diamine chain extender connecting polymerized prepolymer segments, and the polyurethane binder can have an acid number less than 50. In certain examples, the siloxane-containing diamine can have general structure:

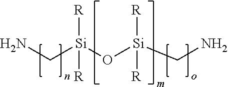

where the R groups are independently methyl, ethyl, or propyl, where n and o are independently integers from 1 to 10, and where m is an integer from 1 to 200.

The present disclosure also describes methods of textile printing. In one example, a method of textile printing includes jetting an ink composition onto a fabric substrate. The ink composition includes water, an organic co-solvent, a colorant, and a polyurethane binder. The polyurethane binder includes polymerized prepolymer segments including a polymerized diisocyanate and a polymerized polyol, wherein the prepolymer segments terminate in isocyanate groups. The polyurethane binder also includes a polymerized siloxane-containing diamine chain extender connecting polymerized prepolymer segments. In further examples, the method can also include curing the ink composition after jetting onto the fabric substrate, wherein curing includes heating the fabric substrate at a curing temperature from 50° C. to 120° C. In a certain example, no additional reactive composition is jetted onto the fabric substrate in order to cure the ink composition. In some examples, the fabric substrate can include cotton, polyester, silk, nylon, or a blend thereof. In further examples, the siloxane-containing diamine can have general structure:

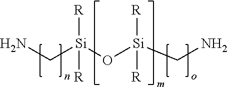

where the R groups are independently methyl, ethyl, or propyl, where n and o are independently integers from 1 to 10, and where m is an integer from 1 to 200.

It is noted that when discussing the ink compositions, textile printing systems, or the methods of textile printing herein, these discussions can be considered applicable to one another whether or not they are explicitly discussed in the context of that example. Thus, for example, when discussing an organic co-solvent related to the ink composition, such disclosure is also relevant to and directly supported in the context of the methods of textile printing, and vice versa. It is also understood that terms used herein will take on their ordinary meaning in the relevant technical field unless specified otherwise. In some instances, there are terms defined more specifically throughout the specification or included at the end of the present specification, and thus, these terms have a meaning as described herein.

The ink compositions described herein can be particularly useful for textile printing. These ink compositions can be cured at lower temperatures than many other textile printing inks. Many types of textile printing inks are cured at high temperatures after printing, such as 150° C. or more. This high temperature curing can expend a large amount of energy and can also limit the ink to being printed on textile materials that can withstand such high temperatures. Some types of textile printing inks are also cured using a separate cross-linker that can be printed together with the ink or added after printing the ink. This can increase the complexity of the printing process by adding an additional cross-linking fluid to be applied to the textile in addition to the ink. Many types of ink used for textiles are also not suitable for ink jet printing. Therefore, much textile printing is performed using other methods such as screen printing.

In contrast with these other types of textile printing inks, the ink compositions described herein can be cured at lower temperatures without an additional cross-linker. The ink compositions can also provide good durability for images printed on textiles, including good wash-fastness after multiple washing cycles. Additionally, the ink compositions can be stable, have a long shelf life, and can be suitable for printing using jetting architecture such as an ink jet printer.

In some examples, the ink compositions described herein can include a particular polyurethane binder that provides good durability of printed images while also providing good stability and jettability of the ink. In various examples, the polyurethane binder can have an acid number less than 50. In other examples, the acid number can be less than 30, less than 20, or less than 10. In further examples, the D50 particle size of the polyurethane binder can be less than 400 nm, less than 300 nm, or less than 200 nm. The polyurethane binder can have an excess of NCO groups to allow self-crosslinking. In still further examples, the polyurethane binder can include a non-ionic siloxane-based diamine chain extender. In additional examples, the polyurethane binder can include an anionic diamine chain extender.

In a particular example, an ink composition can include water, an organic co-solvent, a colorant, and a polyurethane binder. The polyurethane binder can include polymerized prepolymer segments including a polymerized diisocyanate and a polymerized polyol, wherein the prepolymer segments terminate in isocyanate groups. The polyurethane binder can also include polymerized chain extenders connecting the polymerized prepolymer segments, wherein the polymerized chain extenders include a polymerized siloxane-containing diamine and a polymerized acid-containing diamine.

As used herein, “polymerized” is used with respect to monomers or segments of polymers to describe the monomers or segments of polymers in their polymerized state, e.g., after the monomers have bonded together to form a polymer chain. The names of monomers in their original state may be used even though it is understood that the monomers change in certain ways during polymerizing. For example, “polymerized diisocyanate and polyol” can refer to a polymer chain formed by polymerizing a diisocyanate and a polyol, even though the diisocyanate and polyol do not actually exist as separate molecules in the polymer. In the case of polymerized diisocyanates and polyol, a hydrogen atom of the hydroxyl group of the polyol is replaced by a bond between the oxygen atom of the hydroxyl group and the carbon atom of the isocyanate group of the diisocyanate. Thus, the polyol is no longer a polyol, but has become a portion of a polymer chain. However, “polymerized polyol” may still be used to refer to this portion of the polymer chain for the sake of convenience. The portions of the polymer chain formed from diisocyanates or polyols can also be referred to as “diisocyanate units” and “polyol units” for convenience. Similarly, prepolymer segments can be described as being polymerized because the prepolymer segments can react with chain extenders to form longer polymer chains. After formation of the longer polymer chain, the prepolymer segment and the chain extender compounds no longer exist as independent molecules. However, these can be referred to as “polymerized prepolymer segments” and “polymerized chain extenders” for convenience.

Generally, the polyurethane binder can be formed by the following process. A diisocyanate and a polyol can react to form a prepolymer segment. Diisocyanates are compounds that include two isocyanate, or NCO, groups. Polyols are compounds that include two or more hydroxyl groups. When the diisocyanate reacts with the polyol, a hydrogen atom from a hydroxyl group of the polyol is replaced by a bond between the oxygen atom of the hydroxyl group and the carbon atom of an isocyanate group of the diisocyanate. This results in a “urethane linkage” joining together the diisocyanate and the polyol. Multiple diisocyanate and polyol molecules can link together to form a chain of alternating diisocyanate and polyol units. In some examples, an excess of the diisocyanate can be added to this reaction so that the product of the reaction can be prepolymer segments that terminate is diisocyanate units at either end. Thus, the prepolymer segments can have an unreacted isocyanate group at both ends that are available to react with additional monomers.

After forming the prepolymer segments, a chain extender can be added. Generally, a chain extender can include any molecule having two reactive groups that can react with the isocyanate groups at the ends of the prepolymer segments. One chain extender molecule can react with two prepolymer segments to effectively join the segments together, thus extending the polymer chain. Additional chain extender molecules can link the extended polymer chain with additional prepolymer segments to even further extend the chain.

In some examples, the prepolymer segments described above can react with two types of chain extenders. First, a siloxane-containing diamine can be added as a chain extender. The siloxane-containing diamine can be a compound that includes two amino groups that can react with isocyanate groups of the prepolymer segments. The siloxane-containing diamine can also include a siloxane group or multiple siloxane groups located anywhere within the molecule. The second type of chain extender that can be added is an acid-containing diamine. This can be a compound that also has two amino groups available to react with isocyanate groups of the prepolymer segments. The acid-containing diamine can also include an acid group located anywhere within the molecule. In certain examples, the acid group can be a carboxylate group or a sulfonate group.

In some examples, the diisocyanate, polyol, and chain extenders described above can react in the presence of an organic solvent. After the polyurethane chain is complete, water can be added, and the organic solvent can be removed to form an aqueous dispersion of the polyurethane binder. In further examples, an excess of diisocyanate can be used when forming the polyurethane chains so that some unreacted isocyanate groups remain in the polyurethane binder dispersion. In certain examples, the polyurethane binder dispersion can have a D50 particle size from about nm to about 400 nm.

In certain examples, the diisocyanate polymerized in the prepolymer segment can be selected from the following diisocyanates:

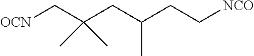

### 2,2,4-trimethylhexane-1,6-diisocyanate (TMDI)

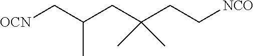

### 2,4,4-trimethylhexane-1,6-diisocyanate (TMDI)

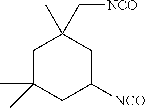

### Isophorone Diisocyanate (IPDI)

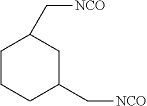

### 1,3-bis(isocyanatamethyl)cyclohexane (H6XDI)

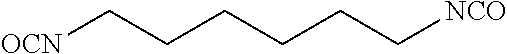

### Hexamethylene Diisocyanate (HDI)

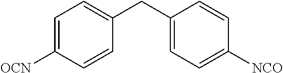

### Methylene Diphenyl Diisocyanate (MDI)

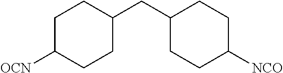

### 4,4′-methylene dicyclohexyl diisocyanate (H12MDI)

or a combination thereof.

In further examples, the polyols that are polymerized in the prepolymer segments can include polymeric diols. Specific examples can include polyether diols, polyester diols, polycarbonate diols, and combinations thereof. Non-limiting examples of commercially available polyols can include the following polyols available from Stepan Company (Illinois): STEPANOL® bc-180, STEPANOL® PC-1011-45, STEPANOL® PC-1011-55, STEPANOL® PC-1011P-110, STEPANOL® PC-1011P-210, STEPANOL® PC-1015-55, STEPANOL® PC-1015P-120, STEPANOL® PC-1017P-55, STEPANOL® PC-101P-55, STEPANOL® PC-102-140, STEPANOL® PC-1021P-70, STEPANOL® PC-102-56, STEPANOL® PC-1028-115, STEPANOL® PC-1028P-210, STEPANOL® PC-1035-55, STEPANOL® PC-1040-55, STEPANOL® PC-1040P-55, STEPANOL® PC-105-10, STEPANOL® PC-105P-110, STEPANOL® PC-105P-30, STEPANOL® PC-107-110, STEPANOL® PC-107P-55, STEPANOL® PC-2011-225, STEPANOL® PC-2011-45, STEPANOL® PC-201-165, STEPANOL® PC-2019-35, STEPANOL® PC-2019-55, STEPANOL® PC-201P-110, STEPANOL® PC-205P-160, STEPANOL® PC-205P-20, STEPANOL® PC-205P-30, STEPANOL® PC-205P-56, STEPANOL® PC-207-125, STEPANOL® PC-2072P-30, STEPANOL® PC-5000P-30, STEPANOL® PC-5010P-35, STEPANOL® PC-5020-130, STEPANOL® PC-5020-160, STEPANOL® PC-5030-270, STEPANOL® PC-5040-167, STEPANOL® PC-5050P-60, STEPANOL® PC-5070P-56, STEPANOL® PC-5080-215, STEPANOL® PC-5080-285, STEPANOL® PC-5100P-56, STEPANOL® PC-5110-58, STEPANOL® PC-5120P-20, STEPANOL® PC-5130-160, STEPANOL® PD-195, STEPANOL® PD-320, STEPANOL® PD-56, STEPANOL® PDC-279, STEPANOL® PDP-70, STEPANOL® PH-56, and STEPANOL® PHN-56.

In some examples, the diisocyanate and the polyol can react together to form prepolymer segments having isocyanate groups at one or both ends of the prepolymer segments. In certain examples, the prepolymer segments can be formed with a NCO/OH ratio from about 1 to about 10. In further examples, the NCO/OH ratio can be from about 1.2 to about 10 or from about 2 to about 3. As used herein, “NCO/OH ratio” refers to the mole ratio of NCO groups to OH groups in the monomers that react to form the prepolymer segment.

The siloxane-containing diamine chain extenders can generally include two amino groups at any locations in the molecule and a siloxane group at any location in the molecule. As used herein, “siloxane group” refers to a Si—O—Si linkage. In some examples, the siloxane-containing diamine can include one Si—O—Si group in the molecule, while in other examples the molecule can include addition oxygen and silicon atoms joined in a chain to form a polysiloxane chain. The siloxane-containing diamine can also include carbon-based organic groups such as alkyl groups, and amino groups.

In certain examples, the siloxane-containing diamine can have the general chemical structure (I):

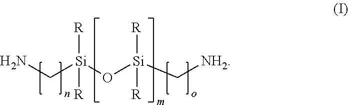

where the R groups are independently methyl, ethyl, or propyl, where n and o are independently integers from 1 to 10, and where m is an integer from 1 to 200. In certain examples, n and o can be 1, 2, or 3. In other examples, m can be 1. In still further examples, the R groups can be methyl groups.

Non-limiting examples of commercially available siloxane-containing diamines can include AFS-8100 and AFS-8100-1000 available from Changshu Changel Chemical Co. Ltd. (China).

The acid-containing diamine can be any compound that includes two amino groups and an acid group. In certain examples, the acid group can be a carboxylate group or a sulphonate group. In a particular example, the acid-containing diamine can include 2-((2-aminoethyl)amino)ethanesulphonate. In one example, the acid-containing diamine can include A-95™ available from Evonik (Germany).

In further examples, the molar ratio of the siloxane-containing diamine chain extender to the acid-containing diamine chain extender can be from about 0.1 to about 3. In still further examples, the ratio can be from about 1 to about 2.5. In some examples, the number of acid groups added to the polyurethane binder by the acid-containing diamine can be sufficient to give the polyurethane binder an acid number from about 1 to about 50, or from about 1 to about 30, or from about 1 to about 20, or from about 1 to about 10.

The polyurethane binder dispersion can generally be included in the ink composition in any amount that does not interfere with the jettability of the ink composition. In some examples, the polyurethane binder can be present in an amount from about 0.1 wt % to about 30 wt % with respect to the total weight of the ink composition. In further examples, the polyurethane binder can be present in an amount from about 0.1 wt % to about 15 wt %, or from about 0.5 wt % to about 10 wt %, or form about 0.6 wt % to 5 wt %, with respect to the total weight of the ink composition.

As mentioned above, the ink compositions can include water, an organic co-solvent, and a colorant in addition to the polyurethane binder. In some examples, the colorant can include a pigment. In some examples, pigment can be included in an amount from about 0.5 wt % to about 15 wt %, or from about 1 wt % to about 10 wt %, or from about 5 wt % to about 10 wt %, based on the total weight of the ink composition.

The pigment can be any of a number of pigments of any of a number of colors, or can be black or white, for example. More specifically, colors can include cyan, magenta, yellow, red, blue, violet, red, orange, green, etc. In one example, the ink composition can be a black ink with a carbon black pigment. In another example, the ink composition can be a cyan or green ink with a copper phthalocyanine pigment, e.g., Pigment Blue 15:0, Pigment Blue 15:1; Pigment Blue 15:3, Pigment Blue 15:4, Pigment Green 7, Pigment Green 36, etc. In another example, the ink composition can be a magenta ink with a quinacridone pigment or a co-crystal of quinacridone pigments. Example quinacridone pigments that can be utilized can include PR122, PR192, PR202, PR206, PR207, PR209, PO48, PO49, PV19, PV42, or the like. These pigments tend to be magenta, red, orange, violet, or other similar colors. In one example, the quinacridone pigment can be PR122, PR202, PV19, or a combination thereof. In another example, the ink composition can be a yellow ink with an azo pigment, e.g., PY74 and PY155. Other examples of pigments include the following, which are available from BASF Corp.: PALIOGEN® Orange, HELIOGEN® Blue L 6901F, HELIOGEN® Blue NBD 7010, HELIOGEN® Blue K 7090, HELIOGEN® Blue L 7101F, PALIOGEN® Blue L 6470, HELIOGEN® Green K 8683, HELIOGEN® Green L 9140, CHROMOPHTAL® Yellow 3G, CHROMOPHTAL® Yellow GR, CHROMOPHTAL® Yellow 8G, IGRAZIN® Yellow 5GT, and IGRALITE® Rubine 4BL. The following pigments are available from Degussa Corp.: Color Black FWI, Color Black FW2, Color Black FW2V, Color Black 18, Color Black, FW200, Color Black 5150, Color Black S160, and Color Black 5170. The following black pigments are available from Cabot Corp.: REGAL® 400R, REGAL® 330R, REGAL® 660R, MOGUL® L, BLACK PEARLS® L, MONARCH® 1400, MONARCH® 1300, MONARCH® 1100, MONARCH® 1000, MONARCH® 900, MONARCH® 880, MONARCH® 800, and MONARCH® 700. The following pigments are available from Orion Engineered Carbons GMBH: PRINTEX® U, PRINTEX® V, PRINTEX® 140U, PRINTEX® 140V, PRINTEX® 35, Color Black FW 200, Color Black FW 2, Color Black FW 2V, Color Black FW 1, Color Black FW 18, Color Black S 160, Color Black S 170, Special Black 6, Special Black 5, Special Black 4A, and Special Black 4. The following pigment is available from DuPont: TI-PURE® R-101. The following pigments are available from Heubach: MONASTRAL® Magenta, MONASTRAL® Scarlet, MONASTRAL® Violet R, MONASTRAL® Red B, and MONASTRAL® Violet Maroon B. The following pigments are available from Clariant: DALAMAR® Yellow YT-858-D, Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, NOVOPERM® Yellow HR, NOVOPERM® Yellow FGL, Hansa Brilliant Yellow 10GX, Permanent Yellow G3R-01, HOSTAPERM® Yellow H4G, HOSTAPERM® Yellow H3G, HOSTAPERM® Orange GR, HOSTAPERM® Scarlet GO, and Permanent Rubine F6B. The following pigments are available from Sun Chemical: QUINDO® Magenta, INDOFAST® Brilliant Scarlet, QUINDO® Red R6700, QUINDO® Red R6713, INDOFAST® Violet, L74-1357 Yellow, L75-1331 Yellow, L75-2577 Yellow, and LHD9303 Black. The following pigments are available from Birla Carbon: RAVEN® 7000, RAVEN® 5750, RAVEN® 5250, RAVEN® 5000 Ultra® II, RAVEN® 2000, RAVEN® 1500, RAVEN® 1250, RAVEN® 1200, RAVEN® 1190 Ultra®. RAVEN® 1170, RAVEN® 1255, RAVEN® 1080, and RAVEN® 1060. The following pigments are available from Mitsubishi Chemical Corp.: No. 25, No. 33, No. 40, No. 47, No. 52, No. 900, No. 2300, MCF-88, MA600, MA7, MA8, and MA100. The colorant may be a white pigment, such as titanium dioxide, or other inorganic pigments such as zinc oxide and iron oxide.

Specific other examples of a cyan color pigment may include C.I. Pigment Blue-1, -2, -3, -15, -15:1, -15:2, -15:3, -15:4, -16, -22, and -60; magenta color pigment may include C.I. Pigment Red-5, -7, -12, -48, -48:1, -57, -112, -122, -123, -146, -168, -177, -184, -202, and C.I. Pigment Violet-19; yellow pigment may include C.I. Pigment Yellow-1, -2, -3, -12, -13, -14, -16, -17, -73, -74, -75, -83, -93, -95, -97, -98, -114, -128, -129, -138, -151, -154, and -180. Black pigment may include carbon black pigment or organic black pigment such as aniline black, e.g., C.I. Pigment Black 1. While several examples have been given herein, it is to be understood that any other pigment can be used that is useful in color modification, or dye may even be used in addition to the pigment.

Furthermore, pigments and dispersants are described separately herein, but there are pigments that are commercially available which include both the pigment and a dispersant suitable for ink composition formulation. Specific examples of pigment dispersions that can be used, which include both pigment solids and dispersant are provided by example, as follows: HPC-K048 carbon black dispersion from DIC Corporation (Japan), HSKBPG-11-CF carbon black dispersion from Dom Pedro (USA), HPC-C070 cyan pigment dispersion from DIC, CABOJET® 250C cyan pigment dispersion from Cabot Corporation (USA), 17-SE-126 cyan pigment dispersion from Dom Pedro, HPF-M046 magenta pigment dispersion from DIC, CABOJET® 265M magenta pigment dispersion from Cabot, HPJ-YO01 yellow pigment dispersion from DIC, 16-SE-96 yellow pigment dispersion from Dom Pedro, or Emacol SF Yellow AE2060F yellow pigment dispersion from Sanyo (Japan).

Thus, the pigment(s) can be dispersed by a dispersant that is adsorbed or ionically attracted to a surface of the pigment, or can be covalently attached to a surface of the pigment as a self-dispersed pigment. In one example, the dispersant can be an acrylic dispersant, such as a styrene (meth)acrylate dispersant, or other dispersant suitable for keeping the pigment suspended in the liquid vehicle. In one example, the styrene (meth)acrylate dispersant can be used, as it can promote rr-stacking between the aromatic ring of the dispersant and various types of pigments. In one example, the styrene (meth)acrylate dispersant can have a weight average molecular weight from 4,000 Mw to 30,000 Mw. In another example, the styrene-acrylic dispersant can have a weight average molecular weight of 8,000 Mw to 28,000 Mw, from 12,000 Mw to 25,000 Mw, from 15,000 Mw to 25,000 Mw, from 15,000 Mw to 20,000 Mw, or about 17,000 Mw. Regarding the acid number, the styrene (meth)acrylate dispersant can have an acid number from 100 to 350, from 120 to 350, from 150 to 300, from 180 to 250, or about 214, for example. Example commercially available styrene-acrylic dispersants can include Joncryl© 671, Joncryl© 71, Joncryl© 96, Joncryl© 680, Joncryl® 683, Joncryl® 678, Joncryl® 690, Joncryl®296, Joncryl® 671, Joncryl® 696 or Joncryl® ECO 675 (all available from BASF Corp., Germany).

The term “(meth)acrylic” refers to monomers, copolymerized monomers, etc., that can either be acrylate or methacrylate (or a combination of both), or acrylic acid or methacrylic acid (or a combination of both), as the acid or salt/ester form can be a function of pH. Furthermore, even if the monomer used to form the polymer was in the form of a (meth)acrylic acid during preparation, pH modifications during preparation or subsequently when added to an ink composition can impact the nature of the moiety as well (acid form vs. salt or ester form). Thus, a monomer or a moiety of a polymer described as (meth)acrylic should not be read so rigidly as to not consider relative pH levels, ester chemistry, and other general organic chemistry concepts.

The ink compositions of the present disclosure can be formulated to include a liquid vehicle, which can include the water content, e.g., 30 wt % to 99 wt %, 50 wt % to 95 wt %, 60 wt % to 90 wt % or from 70 wt % to 90 wt %, as well as organic co-solvent, e.g., from 1 wt % to 40 wt %, from 4 wt % to 30 wt %, from 4 wt % to 20 wt %, or from 5 wt % to 15 wt %. Other liquid vehicle components can also be included, such as surfactant, antibacterial agent, other colorant, etc. However, as part of the ink composition used in the systems and methods described herein, the pigment, dispersant, and polyurethane binder can be included or carried by the liquid vehicle components. Suitable pH ranges for the ink composition can be from pH 6 to pH 10, from pH 7 to pH 10, from pH 7.5 to pH 10, from pH 8 to pH 10, 6 to pH 9, from pH 7 to pH 9, from pH 7.5 to pH 9, etc.

In further detail regarding the liquid vehicle, the co-solvent(s) can be present and can include any co-solvent or combination of co-solvents that is compatible with the pigment, dispersant, and polyurethane binder. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1, 3-propane diol (EPHD), glycerol, dimethyl sulfoxide, sulfolane, glycol ethers, alkyldiols such as 1,2-hexanediol, and/or ethoxylated glycerols such as LEG-1, etc.

The liquid vehicle can also include surfactant and/or emulsifier. In general, the surfactant can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, the surfactant can include a nonionic surfactant, such as a Surfynol® surfactant, e.g., Surfynol® 440 (from Evonik, Germany), or a Tergitol™ surfactant, e.g., Tergitol™ TMN-6 (from Dow Chemical, USA). In another example, the surfactant can include an anionic surfactant, such as a phosphate ester of a C10 to C20 alcohol or a polyethylene glycol (3) oleyl mono/di phosphate, e.g., Crodafos® N3A (from Croda International PLC, United Kingdom). The surfactant or combinations of surfactants, if present, can be included in the ink composition at from about 0.01 wt % to about 5 wt % and, in some examples, can be present at from about 0.05 wt % to about 3 wt % of the ink compositions.

Consistent with the formulations of the present disclosure, various other additives may be included to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, Acticide®, e.g., Acticide® B20 (Thor Specialties Inc.), Nuosept™ (Nudex, Inc.), Ucarcide™ (Union carbide Corp.), Vancide® (R.T. Vanderbilt Co.), Proxel™ (ICI America), and combinations thereof. Sequestering agents, such as EDTA (ethylene diamine tetra acetic acid) or trisodium salt of methylglycinediacetic acid, may be included to eliminate the deleterious effects of heavy metal impurities, and buffer solutions may be used to control the pH of the ink. Viscosity modifiers and buffers may also be present, as well as other additives to modify properties of the ink as desired.

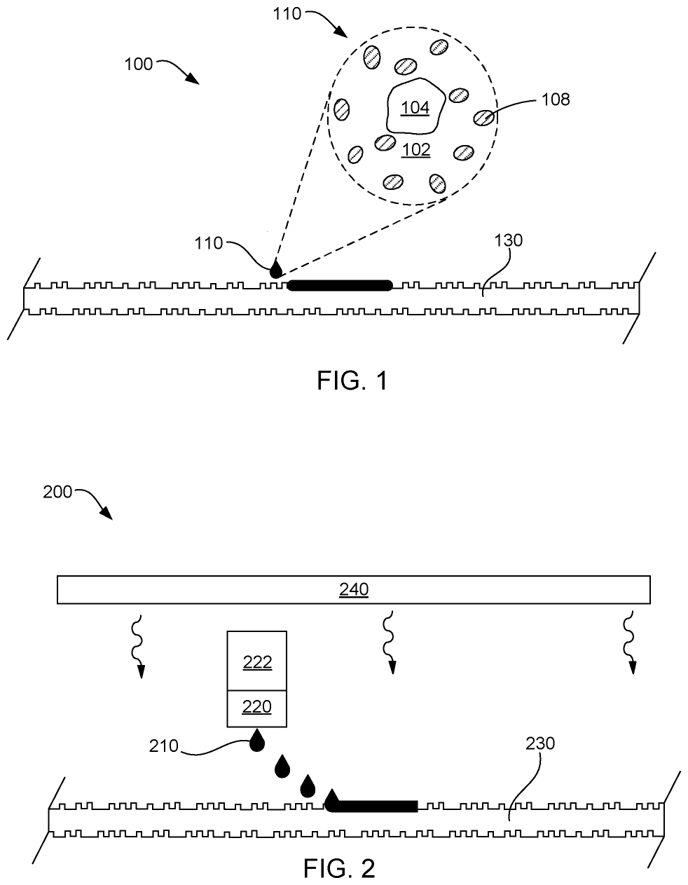

The ink compositions described herein can be used in textile printing systems. FIG. 1 shows an example textile printing system 100 which includes a fabric substrate 130 and an ink composition 110. The ink composition includes water, an organic co-solvent (shown collectively as liquid vehicle 102), pigment 104 as a colorant, and particles of the polyurethane binder 108 described above. The ink composition can also include any of the other ingredients described above. As explained above, the polyurethane binder can give the ink composition good durability when printed. The ink composition can be printed on various types of fabrics, such as cotton, nylon, silk, polyester, cotton/polyester blend, etc. The durability of the printed ink on the fabric can be tested by washing, for example by performing a washfastness test that includes five (5) standard washing machine cycles using warm water and a standard clothing detergent. Acceptable optical density retention and other color properties of the printed inks can be the result. Additionally, the ink compositions can also exhibit good stability over time as well as good thermal inkjet printhead performance such as high drop weight, high drop velocity, and good kogation.

The term “washfastness” can be defined as the optical density (OD) or delta E (ΔE) that is retained after five (5) standard washing machine cycles using warm water and a standard clothing detergent (e.g., Tide® available from Proctor and Gamble, Cincinnati, Ohio, USA). By measuring OD and/or L*a*b* both before and after washing, ΔOD and ΔE value can be determined, which is a quantitative way of expressing the difference between the OD and/or L*a*b*prior to and after undergoing the washing cycles. Thus, the lower the ΔOD and ΔE values, the better. In further detail, ΔE is a single number that represents the “distance” between two colors, which in accordance with the present disclosure, is the color (or black) prior to washing and the modified color (or modified black) after washing.

Colors, for example, can be expressed as CIELAB values. It is noted that color differences may not be symmetrical going in both directions (pre-washing to post washing vs. post-washing to pre-washing). Using the CIE 1976 definition, the color difference can be measured and the ΔE value calculated based on subtracting the pre-washing color values of L*, a*, and b* from the post-washing color values of L*, a*, and b*. Those values can then be squared, and then a square root of the sum can be determined to arrive at the ΔE value. The 1976 standard can be referred to herein as “ΔE_{CIE}.” The CIE definition was modified in 1994 to address some perceptual non-uniformities, retaining the L*a*b* color space, but modifying to define the L*a*b* color space with differences in lightness (L*), chroma (C*), and hue (h*) calculated from L*a*b* coordinates. Then in 2000, the CIEDE standard was established to further resolve the perceptual non-uniformities by adding five corrections, namely i) hue rotation (R_{T}) to deal with the blue region at hue angles of about 275°), ii) compensation for neutral colors or the primed values in the L*C*h differences, iii) compensation for lightness (S_{L}), iv) compensation for chroma (Sc), and v) compensation for hue (S_{H}). The 2000 modification can be referred to herein as “ΔE₂₀₀₀.” In accordance with examples of the present disclosure, ΔE value can be determined using the CIE definition established in 1976, 1994, and 2000 to demonstrate washfastness. However, in the examples of the present disclosure, ΔE_{CIE} is used.

As shown in FIG. 2, a textile printing system 200 can print the ink compositions 210 on fabric substrates 230. For example, the ink compositions can be printed from an inkjet printhead 220 which includes an ejector, such as a thermal inkjet ejector, for example. The printhead is in fluid communication with a reservoir 222 that contains the ink composition. In this example, the textile printing system also includes a curing heat source 240 that can heat the fabric substrate to cure the ink after printing.

These ink compositions can be suitable for printing on many types of textiles, but can be particularly acceptable on treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Treated fabrics can include a coating, for example, such as a coating including a cationic component such as calcium salt, magnesium salt, cationic polymer, etc. These types of substrates can provide acceptable optical density (OD) and/or washfastness properties.

In further detail regarding the fabric substrates, the fabric can include a substrate, and in some examples can be treated, such as with a coating that includes a calcium salt, a magnesium salt, a cationic polymer, or a combination of a calcium or magnesium salt and cationic polymer. Fabric substrates can include substrates that have fibers that may be natural and/or synthetic. The fabric substrate can include, for example, a textile, a cloth, a fabric material, fabric clothing, or other fabric product suitable for applying ink, and the fabric substrate can have any of a number of fabric structures. The term “fabric structure” is intended to include structures that can have warp and weft, and/or can be woven, non-woven, knitted, tufted, crocheted, knotted, and pressured, for example. The terms “warp” and “weft” have their ordinary meaning in the textile arts, as used herein, e.g., warp refers to lengthwise or longitudinal yarns on a loom, while weft refers to crosswise or transverse yarns on a loom.

It is notable that the term “fabric substrate” does not include materials referred to as any kind of paper (even though paper can include multiple types of natural and synthetic fibers or mixtures of both types of fibers). Fabric substrates can include textiles in filament form, textiles in the form of fabric material, or textiles in the form of fabric that has been crafted into a finished article (e.g. clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include but is not limited to, fabric with a plain weave structure, fabric with a twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of two or more of these processes.

Regardless of the structure, in one example, the fabric substrate can include natural fibers, synthetic fibers, or a combination thereof. Exemplary natural fibers can include, but are not limited to, wool, cotton, silk, linen, jute, flax, hemp, rayon fibers, thermoplastic aliphatic polymeric fibers derived from renewable resources (e.g. cornstarch, tapioca products, sugarcanes), or a combination thereof. In another example, the fabric substrate can include synthetic fibers. Exemplary synthetic fibers can include polymeric fibers such as, polyvinyl chloride (PVC) fibers, PVC-free fibers made of polyester, polyamide, polyimide, polyacrylic, polypropylene, polyethylene, polyurethane, polystyrene, polyaramid (e.g., Kevlar©) polytetrafluoroethylene (Teflon®) (both trademarks of E. I. du Pont de Nemours Company, Delaware), fiberglass, polytrimethylene, polycarbonate, polyethylene terephthalate, polyester terephthalate, polybutylene terephthalate, or a combination thereof. In some examples, the synthetic fiber can be a modified fiber from the above-listed polymers. The term “modified fiber” refers to one or both of the polymeric fiber and the fabric as a whole having undergone a chemical or physical process such as, but not limited to, a copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation. The term “PVC-free fibers” as used herein means that no polyvinyl chloride (PVC) polymer or vinyl chloride monomer units are in the fibers.

As previously mentioned, the fabric substrate can be a combination of fiber types, e.g. a combination of any natural fiber with another natural fiber, any natural fiber with a synthetic fiber, a synthetic fiber with another synthetic fiber, or mixtures of multiple types of natural fibers and/or synthetic fibers in any of the above combinations. In some examples, the fabric substrate can include natural fiber and synthetic fiber. The amount of the individual fiber types can vary. For example, the amount of the natural fiber can vary from about 5 wt % to about 95 wt % and the amount of synthetic fiber can range from about 5 wt % to 95 wt %. In yet another example, the amount of the natural fiber can vary from about 10 wt % to 80 wt % and the synthetic fiber can be present from about 20 wt % to about 90 wt %. In other examples, the amount of the natural fiber can be about 10 wt % to 90 wt % and the amount of synthetic fiber can also be about 10 wt % to about 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

In one example, the fabric substrate can have a basis weight ranging from about 10 gsm to about 500 gsm. In another example, the fabric substrate can have a basis weight ranging from about 50 gsm to about 400 gsm. In other examples, the fabric substrate can have a basis weight ranging from about 100 gsm to about 300 gsm, from about 75 gsm to about 250 gsm, from about 125 gsm to about 300 gsm, or from about 150 gsm to about 350 gsm.

In addition, the fabric substrate can contain additives including, but not limited to, colorant (e.g., pigments, dyes, and tints), antistatic agents, brightening agents, nucleating agents, antioxidants, UV stabilizers, fillers, and lubricants, for example. Alternatively, the fabric substrate may be pre-treated in a solution containing the substances listed above before applying other treatments or coating layers.

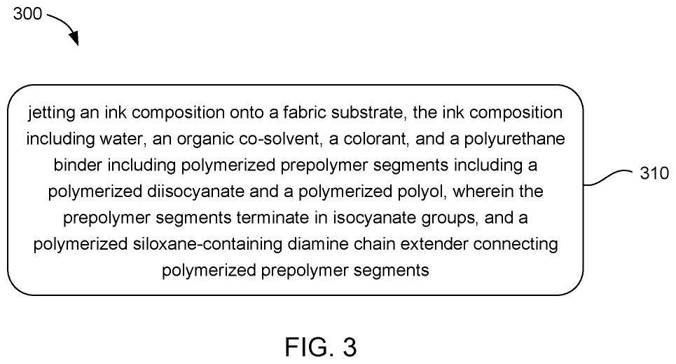

The ink compositions described herein and the textile printing systems described herein can also be used in methods of textile printing. FIG. 3 shows a flowchart of one example method 300 of textile printing. The method includes: jetting 310 an ink composition onto a fabric substrate, the ink composition including: water, an organic co-solvent, a colorant, and a polyurethane binder including: polymerized prepolymer segments including a polymerized diisocyanate and a polymerized polyol, wherein the prepolymer segments terminate in isocyanate groups, and a polymerized siloxane-containing diamine chain extender connecting polymerized prepolymer segments.

As mentioned above, the ink compositions described herein can be cured at a lower temperature compared to other textile printing inks while still having good durability. Therefore, in some examples the method of textile printing can include curing the ink composition after printing on the fabric substrate by heating the fabric substrate. In certain examples, the fabric substrate can be heated to a curing temperature from 50° C. to 120° C. In further examples, the curing temperature can be from 60° C. to 100° C. or from 70° C. to 90° C. The fabric substrate can be heated at this temperature for a curing time. In some examples, the curing time can be from 30 seconds to 30 minutes. In further examples, the curing time can be from 1 minute to 10 minutes, from 1 minute to 5 minutes, or from 1 minute to 3 minutes.

In some cases, a fixer fluid or a cross-linking fluid can be used together with the ink composition. Fixer fluid or cross-linking fluid can be applied to a fabric substrate before, after, or concurrently with the ink composition. Fixer compositions may include, for example, metal salts that can help fix pigments on the fabric substrate. Cross-linking fluids can include cross-linkers that can react with the polyurethane binder in the ink composition to from a cross-linked polymer network. In alternative examples, the ink compositions described herein can be cured without any additional fixer or cross-linker. Thus, the ink composition can be applied to the fabric substrate and cured by heating without jetting an additional reactive composition such as fixer or cross-linker in order to cure the ink composition.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable based on experience and the associated description herein.

The term “acid value” or “acid number” refers to the mass of potassium hydroxide (KOH) in milligrams that can be used to neutralize one gram of substance (mg KOH/g), such as the polyurethane binders disclosed herein. This value can be determined, in one example, by dissolving or dispersing a known quantity of a material in organic solvent and then titrating with a solution of potassium hydroxide (KOH) of known concentration for measurement.

“D50” particle size is defined as the particle size at which about half of the particles are larger than the D50 particle size and about half of the other particles are smaller than the D50 particle size (by weight based on the metal particle content of the particulate build material). As used herein, particle size with respect to the polyurethane binder particles can be based on volume of the particle size normalized to a spherical shape for diameter measurement, for example. Particle size can be collected using a Malvern Zetasizer, for example. Likewise, the “D95” is defined as the particle size at which about 5 wt % of the particles are larger than the D95 particle size and about 95 wt % of the remaining particles are smaller than the D95 particle size. Particle size information can also be determined and/or verified using a scanning electron microscope (SEM), or can be measured using a particle analyzer such as the Mastersizer™ 3000 available from Malvern Panalytical, for example. The particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can then analyze the angular scattering data to calculate the size of the particles using the Mie theory of light scattering. The particle size can be reported as a volume equivalent sphere diameter.

As used herein, a plurality of items, structural elements, compositional elements, and/or materials may be presented in a common list for convenience. However, these lists should be construed as though the members of the list are individually identified as separate and unique members. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, and also to include all the individual numerical values or sub-ranges encompassed within that range as if the numerical values and sub-ranges are explicitly recited. For example, a weight ratio range of about 1 wt % to about 20 wt % should be interpreted to include the explicitly recited limits of about 1 wt % and about 20 wt %, and also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following is merely illustrative of the methods and systems herein. Numerous modifications and alternative methods and systems may be devised without departing from the present disclosure. Thus, while the technology has been described above with particularity, the following provides further detail in connection with what are presently deemed to be the acceptable examples.

### Example 1—Synthesis of Polyurethane Binder (PUB-1)

71.069 g of polyester polyol (Stepanol® PC-1015-55 available from Stepan Company, Illinois), and 20.131 g of isophorone diisocyanate (IPDI) in 42 g of acetone were mixed in a 500 ml of 4-neck round bottom flask. A mechanical stirrer with glass rod and Teflon blade was attached. A condenser was attached. The flask was immersed in a constant temperature bath at 60° C. The system was kept under drying tube. 3 drops of dibutyltin dilaurate (DBTDL) was added to initiate the polymerization. Polymerization was continued for 3 hrs at 60° C. A 0.5-gram sample was withdrawn for % NCO titration to confirm the reaction. The measured NCO value was 5.10%. Theoretical % NCO should be 5.13%. The polymerization temperature was reduced to 40° C. 5.884 g of siloxane-based diamine (AFS-8100, 1 available from Changshu Changel Chemical Co. Ltd., China) and 5.831 g of sodium aminoalkylsulphonate (A-95™ 50% in water, available from Evonik, Germany, which is a sulfonic acid group-containing diamine) aqueous solution in 14.577 g of deionized water were mixed in a beaker until the A-95 was completely dissolved. The siloxane-based diamine and A-95 solution was added to the pre-polymer solution at 40° C. with vigorous stirring over 5 mins. The solution became viscous and slight hazy. The mixture was continued to stir for 30 mins at 40° C. Then 203.723 g of cold deionized water was added to polymer mixture in the 4-neck round bottom flask over 10 mins with good agitation to form a polyurethane (PUB) dispersion. The agitation was continued for 60 mins at 40° C. The PUB dispersion was filtered through a 400-mesh stainless sieve. Acetone was removed with rotorvap at 40° C. (adding 2 drops (20 mg) BYK-011 de-foaming agent, available from BYK-CHEMIE GMBH, Germany). The final PUB dispersion was filtered through fiber glass filter paper. Particle size (D50) measured by Malvern Zetasizer was 104.8 nm. The pH was 7. The acid number was 8.6. Solid content was 26.95%.

### Example 2—Synthesis of Polyurethane Binder (PUB-2)

71.851 g of polyester polyol (Stepanol® PC-1015-55 available from Stepan Company, Illinois), and 19.253 g of 2,2,4 (or 2,4,4)-trimethylhexane-1,6-diisocyanate (TMDI) in 80 g of acetone were mixed in a 500 ml of 4-neck round bottom flask. A mechanical stirrer with glass rod and Teflon blade was attached. A condenser was attached. The flask was immersed in a constant temperature bath at 75° C. The system was kept under a drying tube. 3 drops of dibutyltin dilaurate (DBTDL) were added to initiate the polymerization. Polymerization was continued for 6 hrs at 75° C. A 0.5-gram sample was withdrawn for % NCO titration to confirm the reaction. The measured NCO value was 5.16%. Theoretical % NCO should be 5.19%. The polymerization temperature was reduced to 50° C. 5.949 g of siloxane-based diamine (AFS-8100, 1 available from Changshu Changel Chemical Co. Ltd., China), 5.895 g of sodium aminoalklysulphonate (A-95, 50% in water, available from Evonik, Germany) and 14.737 g of deionized water were mixed in a beaker until siloxane-based diamine and A-95 were completely dissolved. The siloxane-based diamine and A-95 solution was added to the pre-polymer solution at 50° C. with vigorous stirring over 5 mins. The solution became viscous and slight hazy. The mixture was continued to stir for 30 mins at 50° C. Then 203.660 g of cold deionized water was added to polymer mixture in the 4-neck round bottom flask over 10 mins with good agitation to form a PUB dispersion. The agitation was continued for 60 mins at 50° C. The PUB dispersion was filtered through a 400-mesh stainless sieve. Acetone was removed with rotorvap at 50° C. (adding 2 drops (20 mg) BYK-011 de-foaming agent, available from BYK-CHEMIE GMBH, Germany). The final PUB dispersion was filtered through fiber glass filter paper. Particle size (D50) measured by Malvern Zetasizer was 83.44 nm. The pH was 7. The acid number was 8.7. Solid content was 30.51%.

### Example 3—Synthesis of Polyurethane Binder (PUB-3)

60.454 g of polyester polyol (Stepanol® PC-1015-55 available from Stepan Company, Illinois), and 17.124 g of isophorone diisocyanate (IPDI) in 80 g of acetone were mixed in a 500 ml 4-neck round bottom flask. A mechanical stirrer with glass rod and Teflon blade was attached. A condenser was attached. The flask was immersed in a constant temperature bath at 75° C. The system was kept under a drying tube. 3 drops of dibutyltin dilaurate (DBTDL) were added to initiate the polymerization. Polymerization was continued for 6 hrs at 75° C. A 0.5-gram sample was withdrawn for % NCO titration to confirm the reaction. The measured NCO value was 5.10%. Theoretical % NCO should be 5.13%. The polymerization temperature was reduced to 50° C. 19.942 g of siloxane-based diamine (AFS-8100-1000, 2 available from Changshu Changel Chemical Co. Ltd., China), 4.96 g of sodium aminoalklysulphonate (A-95, 50% in water, available from Evonik, Germany) and 12.399 g of deionized water were mixed in a beaker until siloxane-based diamine and A-95 were completely dissolved. The siloxane-based diamine and A-95 solution was added to the pre-polymer solution at 50° C. with vigorous stirring over 5 mins. The solution became viscous and slight hazy. The mixture was continued to stir for 30 mins at 50° C. Then 201.713 g of cold deionized water was added to polymer mixture in 4-neck round bottom flask over 10 mins with good agitation to form PUB dispersion. The agitation was continued for 60 mins at 50° C. The PUB dispersion was filtered through 400 mesh stainless sieve. Acetone was removed with rotorvap at 50° C. (add 2 drops (20 mg) BYK-011 de-foaming agent, available from BYK-CHEMIE GMBH, Germany). The final PUB dispersion was filtered through fiber glass filter paper. Particle size (D50) measured by Malvern Zetasizer is 101.8 nm. Its pH was 7. The acid number was 7.3. Solid content was 25.99%.

### Example 4—Synthesis of Polyurethane Binder (PUB-4)

61.109 g of polyester polyol (Stepanol® PC-1015-55 available from Stepan Company, Illinois), and 16.350 g of 2,2,4 (or 2, 4, 4)-trimethylhexane-1,6-diisocyanate (TMDI) in 80 g of acetone were mixed in a 500 ml 4-neck round bottom flask. A mechanical stirrer with glass rod and Teflon blade was attached. A condenser was attached. The flask was immersed in a constant temperature bath at 75° C. The system was kept under drying tube. 3 drops of dibutyltin dilaurate (DBTDL) were added to initiate the polymerization. Polymerization was continued for 6 hrs at 75° C. A 0.5-gram sample was withdrawn for % NCO titration to confirm the reaction. The measured NCO value was 5.15%. Theoretical % NCO should be 5.19%. The polymerization temperature was reduced to 50° C. 20.128 g of siloxane-based diamine (AFS-8100-1000, 2 available from Changshu Changel Chemical Co. Ltd., China), 5.006 g of sodium aminoalklysulphonate (A-95, 50% in water, available from Evonik, Germany) and 12.515 g of deionized water were mixed in a beaker until the siloxane-based diamine and A-95 were completely dissolved. The siloxane-based diamine and A-95 solution was added to the pre-polymer solution at 50° C. with vigorous stirring over 5 mins. The solution became viscous and slight hazy. The mixture was continued to stir for 30 mins at 50° C. Then 201.829 g of cold deionized water was added to polymer mixture in the 4-neck round bottom flask over 10 mins with good agitation to form a PUB dispersion. The agitation was continued for 60 mins at 50° C. The PUB dispersion was filtered through a 400 mesh stainless sieve. Acetone was removed with rotorvap at 50° C. (adding 2 drops (20 mg) BYK-011 de-foaming agent, available from BYK-CHEMIE GMBH, Germany). The final PUB dispersion was filtered through fiber glass filter paper. Particle size (D50) measured by Malvern Zetasizer was 97.52 nm. The pH was 7. The acid number was 7.4. Solid content was 26.95%.

### Example 5—Synthesis of Polyurethane Binder (PUB-5)

61.689 g of polyester polyol (Stepanol® PC-1015-55 available from Stepan Company, Illinois), and 15.294 g of 1,3-bis(isocyanatomethyl)cyclohexane (Takenate 600, H6XDI) in 80 g of acetone were mixed in a 500 ml of 4-neck round bottom flask. A mechanical stirrer with glass rod and Teflon blade was attached. A condenser was attached. The flask was immersed in a constant temperature bath at 75° C. The system was kept under a drying tube. 3 drops of dibutyltin dilaurate (DBTDL) were added to initiate the polymerization. Polymerization was continued for 6 hrs at 75° C. A 0.5-gram sample was withdrawn for % NCO titration to confirm the reaction. The measured NCO value was 5.25%. Theoretical % NCO should be 5.28%. The polymerization temperature was reduced to 50° C. 20.382 g of siloxane-based diamine (AFS-8100-1000, 2 available from Changshu Changel Chemical Co. Ltd., China), 5.069 g of sodium aminoalklysulphonate (A-95, 50% in water, available from Evonik, Germany) and 12.673 g of deionized water were mixed in a beaker until the siloxane-based diamine and A-95 were completely dissolved. The siloxane-based diamine and A-95 solution was added to the pre-polymer solution at 50° C. with vigorous stirring over 5 mins. The solution became viscous and slight hazy. The mixture was continued to stir for 30 mins at 50° C. Then cold 201.640 g of deionized water was added to polymer mixture in the 4-neck round bottom flask over 10 mins with good agitation to form PUB dispersion. The agitation was continued for 60 mins at 50° C. The PUB dispersion was filtered through a 400-mesh stainless sieve. Acetone was removed with rotovap at 50° C. (adding 2 drops (20 mg) BYK-011 de-foaming agent, available from BYK-CHEMIE GMBH, Germany). The final PUB dispersion was filtered through fiber glass filter paper. Particle size (D50) measured by Malvern Zetasizer was 185.77 nm. The pH was 7. The acid number was 7.5. Solid content was 34.41%.

### Example 6—Preparation of Ink Compositions (Ink)

The polyurethane binders PUB-1 through PUB-5 were used to prepare several ink formulations that included: 6 wt % of one of the polyurethane binder dispersion selected from PUB-1 through PUB-5, 6 wt % glycerol as a co-solvent, 0.5 wt % of Crodafos® N3 Acid (available from Croda Personal Care, United Kingdom), 1 wt % of Liponic® EG-1 as a co-solvent (available from Vantage Specialty Chemicals, Illinois), 0.22 wt % of Acticide® B20 biocide (available from Thor, United Kingdom), 0.3 wt % of Surfynol® 440 surfactant (available from Evonik, Germany), and 3 wt % HPF-M046 magenta pigment dispersion (available from DIC Corporation, Japan). The only difference between the ink compositions was the selection of the ink composition. A sixth ink composition was also prepared as a comparative that included Impranil® DLN-SD (available from Covestro AG, Germany) as the polyurethane binder. The comparative Impranil® DLN-SD polyurethane does not include polymerized siloxane-containing diamines.

### Example 7—Washfastness

The sample ink compositions of Example 6 were printed onto gray cotton fabric using a test inkjet printer. A set of printed samples was cured at 80° C. for 3 minutes, and another set of printed samples was cured at 150° C. for 3 minutes. The cured samples were then washed for 5 cycles using a washing machine at 40° C. with detergent and then air dried. The change in optical density and ΔE_{CIE} were measured to compare the samples before washing and the samples after washing. The washfastness test data is shown in Table 1. As mentioned, in addition to the ink compositions with the polyurethanes of the present disclosure, a control sample was also tested for washfastness that included a commercial polyurethane binder (Impranil® DLN-SD) instead of the polyurethane binder described herein. The comparative Impranil® DLN-SD polyurethane does not include polymerized siloxane-containing diamines.

TABLE 1

| Print | 80° C./3 min | | | | 150° C./3 min | | | |
|---|---|---|---|---|---|---|---|---|
| PUB ID | Before | After 5 | | | Before | After 5 | | |
| In Ink | Wash | Washes | ΔOD % | ΔE_{CIE} | Wash | Washes | ΔOD % | ΔE_{CIE} |
| PUB-1 | 0.960 | 0.950 | −2.0 | 2.8 | 0.968 | 0.950 | −1.8 | 2.8 |
| PUB-2 | 0.965 | 0.940 | −3.6 | 3.3 | 0.942 | 0.881 | −6.5 | 5.6 |
| PUB-3 | 0.908 | 0.769 | −15.3 | 7.9 | 0.914 | 0.880 | −3.7 | 4.5 |
| PUB-4 | 0.891 | 0.796 | −10.7 | 9.3 | 0.891 | 0.845 | −5.2 | 3.5 |
| PUB-5 | 1.018 | 0.960 | −5.2 | 3.5 | 1.024 | 0.939 | −8.3 | 5.8 |
| Impranil ® | 0.992 | 0.849 | −14.4 | 7.8 | 1.011 | 0.975 | −3.6 | 3.2 |
| DLN-SD | | | | | | | | |

These data show that polyurethane binders PUB-1, PUB-2, and PUB-5 had particularly promising wash durability even when cured at 80° C. without additional crosslinkers, with particular good data relative to the comparative Impranil® DLN-SD at 80° C., which is a different type of polyurethane.

### Example 8—Ink Stability

An Accelerated Shelf Life (ASL) test was performed for the ink compositions described in Example 6. The ASL data was collected for the ink compositions before and after 1 week of storage at 60° C. The % A data below relates to a comparison prior to ASL storage and after 1 week of storage, where Viscosity refers to the fluid viscosity of the ink compositions; pH refers to the pH of the ink composition; Mv refers to Volume Averaged Particle Size which approximates the D50 particle size; and D95 refers to the 95 Percentile Particle Size. The ASL data are shown in Table 2.

TABLE 2

| PUB ID | | | | |
|---|---|---|---|---|
| In Ink | % Δ Viscosity | Δ pH | % Δ Mv | % Δ D95 |
| PUB-1 | −4.8 | −0.08 | −3.3 | −3.6 |
| PUB-2 | −4.8 | −0.17 | −5.1 | −7.0 |
| PUB-3 | 0.0 | −0.21 | −6.6 | −2.3 |
| PUB-4 | −4.8 | −0.12 | −3.9 | −8.0 |
| PUB-5 | 0.0 | −0.01 | −6.1 | −1.5 |
| Impranil ® | −12.5 | −0.10 | −11.1 | −33.1 |
| DLN-SD | | | | |

The ASL data show that all of the inks had good ink stability, with better numbers particularly with respect to viscosity and particle size (Mv and D95) relative to the comparative polyurethane Impranil® DLN-SD.

### Example 9—Print Performance

The ink compositions from Example 6 were evaluated for print performance from a thermal inkjet pen (A3410, available from HP, Inc., California). The data was collected according to the following procedures:

Decap is determined using the indicated time (1 second or 7 seconds) where nozzles remain open (uncapped), and then the number of lines missing (or line spits until a good line is printed) during a print event are recorded. Thus, the lower the number the better for decap performance

Percent (%) Missing Nozzles is calculated based on the number of nozzles incapable of firing at the beginning of a jetting sequence as a percentage of the total number of nozzles on an inkjet printhead attempting to fire. Thus, the lower the percentage number, the better the Percent Missing Nozzles value.

Drop Weight (DW) is an average drop weight in nanograms (ng) across the number of nozzles fired measured using a burst mode or firing at 0.75 Joules.

Drop Weight 2,000 (DW 2K) is measured using a 2-drop mode of firing, firing 2,000 drops and then measuring/calculating the average ink composition drop weight in nanograms (ng).

Drop Volume (DV) refers to an average velocity of the drop as initially fired from the thermal inkjet nozzles.

Decel refers to the loss in drop velocity after 5 seconds of ink composition firing.

The print performance data are shown in Table 3.

TABLE 3

| PUB ID | Decap | Decap | % Missing | | | | |
|---|---|---|---|---|---|---|---|
| in Ink | (1 s) | (7 s) | Nozzles | DW | DW 2K | DV | Decel |
| PUB-1 | 11 | 18 | 3.1 | 10.7 | 9.5 | 9.0 | 0.0 |
| PUB-2 | 12 | 17 | 7.3 | 11.2 | 7.8 | 9.1 | 0.0 |
| PUB-3 | 15 | 35 | 34.4 | 8.9 | 3.3 | 6.9 | 0.5 |
| PUB-4 | 15 | 40 | 40.6 | 8.9 | 5.0 | 6.8 | 0.5 |
| PUB-5 | 12 | 18 | 3.1 | 11.7 | 10.5 | 12.3 | 0.2 |
| Impranil ® | 7 | 15 | 1.0 | 12.5 | 11.7 | 13.2 | 0.0 |
| DLN-SD | | | | | | | |

The inks with PUB-1, PUB-2, and PUB-5 had particularly good print performance results, and all of the samples of the present disclosure compared favorably against the commercially available comparative Impranil® DLN-SD polyurethane, which does not include polymerized siloxane-containing diamines in accordance with the present disclosure.

What is claimed is:

1. An ink composition, comprising:
water;
an organic co-solvent;
a colorant; and
a polyurethane binder comprising:
polymerized prepolymer segments including a polymerized diisocyanate and a polymerized polyol, wherein the prepolymer segments terminate in isocyanate groups, and
polymerized chain extenders connecting the polymerized prepolymer segments, wherein the polymerized chain extenders include a polymerized siloxane-containing diamine.

2. The ink composition of claim 1, wherein the diisocyanate comprises 2,2,4-trimethylhexane-1,6-diisocyanate (TMDI); 2,4,4-trimethylhexane-1,6-diisocyanate (TMDI); isophorone diisocyanate (IPDI); 1,3-bis(isocyanatamethyl)cyclohexane (H6XDI); hexamethylene diisocyanate (HDI); methylene diphenyl diisocyanate (MDI); 4,4′-methylene dicyclohexyl diisocyanate (H12MDI); or a combination thereof.

3. The ink composition of claim 1, wherein the siloxane-containing diamine has general structure: 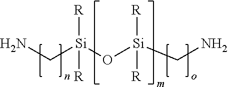
where the R groups are independently methyl, ethyl, or propyl, where n and o are independently integers from 1 to 10, and where m is an integer from 1 to 200.

4. The ink composition of claim 1, wherein the acid-containing diamine is 2-((2-aminoethyl)amino)ethanesulphonate.

5. The ink composition of claim 1, wherein the polyurethane binder further comprises a polymerized acid-containing diamine chain extender connecting polymerized prepolymer segments, and wherein the polyurethane binder has an acid number less than 50.

6. The ink composition of claim 1, wherein the polyurethane binder is present in an amount from 0.1 wt % to 30 wt % with respect to the total weight of the ink composition.

7. A textile printing system, comprising:
a fabric substrate,
an inkjet printhead in fluid communication with a reservoir containing an ink composition to eject the ink composition, the ink composition comprising:
water,
an organic co-solvent,
a colorant, and
a polyurethane binder comprising:
polymerized prepolymer segments including a polymerized diisocyanate and a polymerized polyol, wherein the prepolymer segments terminate in isocyanate groups, and
a polymerized siloxane-containing diamine chain extender connecting polymerized prepolymer segments.

8. The textile printing system of claim 7, wherein the fabric substrate includes cotton, polyester, silk, nylon, or a blend thereof.

9. The textile printing system of claim 7, wherein the polyurethane binder further comprises a polymerized acid-containing diamine chain extender connecting polymerized prepolymer segments, and wherein the polyurethane binder has an acid number less than 50.

10. The textile printing system of claim 7, wherein the siloxane-containing diamine has general structure: 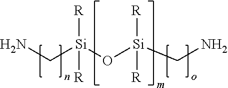
where the R groups are independently methyl, ethyl, or propyl, where n and o are independently integers from 1 to 10, and where m is an integer from 1 to 200.

11. A method of textile printing, comprising:
jetting an ink composition onto a fabric substrate, the ink composition comprising:
water,
an organic co-solvent,
a colorant, and
a polyurethane binder comprising:
polymerized prepolymer segments including a polymerized diisocyanate and a polymerized polyol, wherein the prepolymer segments terminate in isocyanate groups, and
a polymerized siloxane-containing diamine chain extender connecting polymerized prepolymer segments.

12. The method of claim 11, further comprising curing the ink composition after jetting onto the fabric substrate, wherein curing comprises heating the fabric substrate at a curing temperature from 50° C. to 120° C.

13. The method of claim 11, wherein no additional reactive composition is jetted onto the fabric substrate in order to cure the ink composition.

14. The method of claim 11, wherein the fabric substrate includes cotton, polyester, silk, nylon, or a blend thereof.

15. The method of claim 11, wherein the siloxane-containing diamine has general structure: 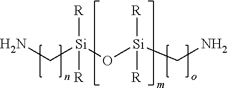
where the R groups are independently methyl, ethyl, or propyl, where n and o are independently integers from 1 to 10, and where m is an integer from 1 to 200.
